(19) United States
(12) Patent Application Publication
(10) Pub. No.: US 2025/0191367 A1
(43) Pub. Date: Jun. 12, 2025

(54) VIDEO TEMPORAL ACTION LOCALIZATION METHOD AND DEVICE

(71) Applicant: POSTECH RESEARCH AND BUSINESS DEVELOPMENT FOUNDATION, Pohang-si (KR)

(72) Inventors: Youngkil SONG, Pohang-si (KR); Suha KWAK, Pohang-si (KR); Dongkeun KIM, Pohang-si (KR); Minsu CHO, Pohang-si (KR)

(21) Appl. No.: 18/924,930

(22) Filed: Oct. 23, 2024

(30) Foreign Application Priority Data
Dec. 8, 2023 (KR) 10-2023-0177837
Aug. 27, 2024 (KR) 10-2024-0114920

(51) Int. Cl. G06V 20/40; G06V 10/764; G06V 10/77; G06V 10/82

(52) U.S. Cl. CPC G06V 20/41; G06V 10/764; G06V 10/7715; G06V 10/82; G06V 20/46

(57) ABSTRACT

A video action localization method may comprise: receiving a first segment included in a video at a current timestamp; extracting features of the first segment; and acquiring a predicted start timestamp, end timestamp, and action class of an action region in the video by inputting the extracted features of the first segment and features of segments stored in a memory queue at previous timestamps to a neural network, wherein each of the segments stored in the memory queue at the previous timestamps satisfies a certain condition.

### CROSS-REFERENCE TO RELATED APPLICATIONS

This application claims priority to Korean Patent Applications No. 10-2023-0177837, filed on Dec. 8, 2023, and No. 10-2024-0114920, filed on Aug. 27, 2024, with the Korean Intellectual Property Office (KIPO), the entire contents of which are hereby incorporated by reference.

### BACKGROUND

### 1. Technical Field

Exemplary embodiments of the present disclosure relate in general to a video temporal action localization method and device, and more particularly, to a technology for predicting a type of action and a start time and an end time of the action in a real-time video.

### 2. Related Art

Temporal action localization is a technology for detecting a region in which an action occurs and estimating an action name of the region when a video in which the region with the action and another region without any action are mixed is input.

Online temporal action localization is a technology for, when a streaming video with an unknown end time is used as an input, localizing a region in the video where an action occurs based on a current frame without using any information about the future and estimating the action in the region. The online temporal action localization technology may be utilized in real-time sports video analysis, closed-circuit television (CCTV) video monitoring, and the like. Online temporal action localization technology according to the related art has two limitations. The first limitation is that it is not possible to utilize information about the future, and the second limitation is that it is not possible to correct any result generated in the past.

### SUMMARY

Accordingly, exemplary embodiments of the present disclosure are provided to substantially obviate one or more problems due to limitations and disadvantages of the related art.

Exemplary embodiments of the present disclosure provide a real-time video action localization method and device for selectively using past information.

Exemplary embodiments of the present disclosure also provide a method and device for predicting an action region even when both a start timestamp and an end timestamp are not included in current input frames. To this end, exemplary embodiments of the present disclosure provide a method and device for sequentially detecting an end timestamp and a start timestamp related to the end timestamp.

Exemplary embodiments of the present disclosure also provide a method and device for localizing an action instance using a memory queue.

According to a first exemplary embodiment of the present disclosure, a video action localization device may comprise: a memory configured to store at least one instruction; a processor configured to execute the at least one instruction; and a neural network, wherein the processor receives a first segment included in a video at a current timestamp, extracts features of the first segment, and inputs the extracted features of the first segment and features of segments stored in a memory queue of the memory at previous timestamps to the neural network to acquire a predicted start timestamp, end timestamp, and action class of an action region in the video, and each of the segments stored in the memory queue at the previous timestamps satisfies a certain condition.

Each of the segments stored in the memory queue at the previous timestamps may be predicted to include at least a part of the action region.

The neural network may include an encoder and a flag prediction head, and the processor may generate combination data by combining the features of the first segment and a flag token, acquire encoded combination data by inputting the combination data to the encoder, predict whether the first segment includes at least a part of the action region by inputting an encoded flag token included in the encoded combination data to the flag prediction head, and store the features of the first segment in the memory queue when it is predicted that the first segment includes at least a part of the action region.

The neural network may further include an end decoder and an end prediction head, and the processor may acquire first output embeddings that are used for detecting whether an action ends in a time period to which the first segment belongs by inputting the features of an encoded first segment included in the encoded combination data and instance queries to the end decoder, and predict an end timestamp by inputting the first output embeddings to the end prediction head.

The neural network may further include a start decoder and a start prediction head, and the processor may concatenate the extracted features of the first segment and the features of the segments stored in the memory queue at the previous timestamps, acquire second output embeddings that are used for predicting the start timestamp of the action region by inputting the concatenated memory features and the first output embeddings to the start decoder, and predict the start timestamp by inputting the second output embeddings to the start prediction head.

The instance queries may include class queries and boundary queries, an end boundary embedding corresponding to the boundary queries among the first output embeddings may be input to the end prediction head, and a start boundary embedding corresponding to the boundary queries among the second output embeddings may be input to the start prediction head.

The neural network may further include an action classification head, and the processor may generate a concatenated class embedding by concatenating an end class embedding corresponding to the class queries among the first output embeddings and a start class embedding corresponding to the class queries among the second output embeddings and predict the action class of the video by inputting the concatenated class embedding to the action classification head.

The processor may uniformly sample the concatenated memory features and input the sampled memory features and the first output embeddings to the start decoder.

The same positional embedding may be applied to a first class query and a first boundary query corresponding to the first class query among a plurality of pairs of class and boundary queries included in the instance queries.

The same positional embedding may be applied to the instance queries input to the end decoder and the first output embeddings input to the start decoder.

According to a second exemplary embodiment of the present disclosure, a video action localization method may comprise: receiving a first segment included in a video at a current timestamp; extracting features of the first segment; and acquiring a predicted start timestamp, end timestamp, and action class of an action region in the video by inputting the extracted features of the first segment and features of segments stored in a memory queue at previous timestamps to a neural network, wherein each of the segments stored in the memory queue at the previous timestamps satisfies a certain condition.

Each of the segments stored in the memory queue at the previous timestamps may be predicted to include at least a part of the action region.

The video action localization method may further comprise: generating combination data by combining the features of the first segment and a flag token; acquiring encoded combination data by inputting the combination data to an encoder of the neural network; predicting whether the first segment includes at least a part of the action region by inputting an encoded flag token included in the encoded combination data to a flag prediction head of the neural network; and storing the features of the first segment in the memory queue when it is predicted that the first segment includes at least a part of the action region.

The acquiring of the predicted start timestamp, end timestamp, and action class may comprise: acquiring first output embeddings that are used for detecting whether an action ends in a time period to which the first segment belongs by inputting the features of an encoded first segment included in the encoded combination data and instance queries to an end decoder; and predicting the end timestamp by inputting the first output embeddings to an end prediction head.

The acquiring of the predicted start timestamp, end timestamp, and action class may further comprise: concatenating the extracted features of the first segment and the features of the segments stored in the memory queue at the previous timestamps; acquiring second output embeddings that are used for predicting the start timestamp of the action region by inputting the concatenated memory features and the first output embeddings to a start decoder of the neural network; and predicting the start timestamp by inputting the second output embeddings to a start prediction head of the neural network.

The instance queries may include class queries and boundary queries, an end boundary embedding corresponding to the boundary queries among the first output embeddings may be input to the end prediction head, and a start boundary embedding corresponding to the boundary queries among the second output embeddings may be input to the start prediction head.

The acquiring of the predicted start timestamp, end timestamp, and action class may further comprise: generating a concatenated class embedding by concatenating an end class embedding corresponding to the class queries among the first output embeddings and a start class embedding corresponding to the class queries among the second output embeddings; and predicting the action class of the video by inputting the concatenated class embedding to an action classification head of the neural network.

The acquiring of the predicted start timestamp, end timestamp, and action class may further comprise: after the concatenating of the extracted features of the first segment and the features of the segments stored in the memory queue at the previous timestamps, uniformly sampling the concatenated memory features; and inputting the sampled memory features and the first output embeddings to the start decoder.

The same positional embedding may be applied to a first class query and a first boundary query corresponding to the first class query among a plurality of pairs of class and boundary queries included in the instance queries.

The same positional embedding may be applied to the instance queries input to the end decoder and the first output embeddings input to the start decoder.

According to the present disclosure, it is possible to provide a real-time video action localization method and device employing a memory selectively storing past information.

According to the present disclosure, it is possible to predict an action region even when both a start timestamp and an end timestamp are not included in current input frames. Specifically, it is possible to provide a method and device for sequentially detecting an end timestamp and a start timestamp related to the end timestamp.

According to the present disclosure, a memory queue is used to utilize long-term context and lower dependency on dataset-specific hyperparameters such that an action instance can be accurately localized.

### BRIEF DESCRIPTION OF DRAWINGS

FIG. 1 is a diagram schematically illustrating a video action localization method according to an exemplary embodiment of the present disclosure.

FIG. 2 is a block diagram illustrating a video action localization device according to an exemplary embodiment of the present disclosure.

FIG. 3 is a diagram illustrating a segment encoder and a memory queue according to an exemplary embodiment of the present disclosure.

FIG. 4 shows a pseudo code for updating a memory queue according to an exemplary embodiment of the present disclosure.

FIG. 5 is a diagram illustrating an instance decoding module according to an exemplary embodiment of the present disclosure.

FIG. 6 is a diagram showing an architecture of an end decoder according to an exemplary embodiment of the present disclosure.

FIG. 7 is a diagram showing an architecture of a start decoder according to an exemplary embodiment of the present disclosure.

FIG. 8 is a diagram illustrating prediction heads according to an exemplary embodiment of the present disclosure.

FIG. 9 is a flowchart illustrating a video action localization method according to an exemplary embodiment of the present disclosure.

FIG. 10 is a flowchart illustrating a process of storing video segments in a memory queue according to an exemplary embodiment of the present disclosure.

FIG. 11 is a diagram comparatively illustrating results of predicting an action region according to an exemplary embodiment of the present disclosure and the related art.

FIG. 12 is a diagram comparatively illustrating results of predicting an action region according to an exemplary embodiment of the present disclosure and the related art.

FIG. 13 is a set of graphs of variation in performance versus the length of a segment used for each prediction according to an exemplary embodiment of the present disclosure.

FIG. 14 is a conceptual diagram of an example of a generalized video action localization device or a computing system that may perform at least a part of the process of FIGS. 1 to 13.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

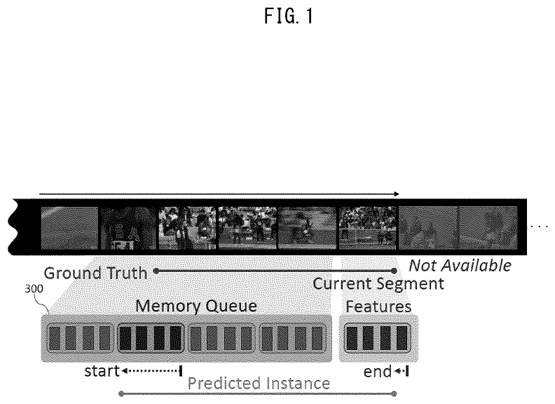

FIG. 1 is a diagram schematically illustrating a video action localization method according to an exemplary embodiment of the present disclosure.

Video action localization/detection methods according to the related art include an online action detection (OAD) method, an online temporal action localization (On-TAL) method, and the like. Among the methods, according to the OAD method, an action is estimated in each frame of a real-time streaming video, that is, online action determination is performed first, and an action prediction result of each frame is aggregated to estimate a region in which a specific action occurs. However, even when the region in which the specific action occurs is incorrectly predicted in only one frame, the region is not predicted normally. According to the On-TAL method, a current frame and past frames of a fixed length based on the current frame are received as an input, and start and end timestamps of a region closely related to the input are predicted. In this way, a region in which an action occurs may be predicted without prediction of frames between the start and end timestamps. However, this method requires a large number of frames as an input at one time to estimate most action regions.

To solve the foregoing problem, a memory queue in which past information is stored as shown in FIG. 1 is used in the present disclosure such that the number of frames used as an input for each prediction can be set more freely and robustly against the size of an action region to be predicted.

Here, a frame may be an image of each timestamp. A certain number of consecutive frames (e.g., four frames in FIG. 1) may be referred to as a “segment.” The number of frames included in one segment may be referred to as a “segment length.” Frame-level features may be referred to as “segment features.”

According to the present disclosure, even when both start and end timestamps are not included in current input frames, it is possible to predict an action region. For example, when an action end timestamp is detected in an input segment of a streaming video, an action start timestamp can be detected by searching the memory queue for information.

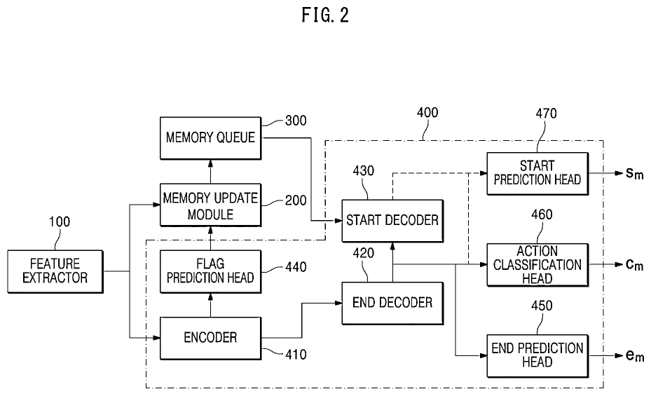

FIG. 2 is a block diagram illustrating a video action localization device according to an exemplary embodiment of the present disclosure.

In the present disclosure, a video may be, for example, an untrimmed video V={vᵢ}ᵢ₌₁^{T} having T frames and M action instances Ψ={(sₘ, eₘ, cₘ)}ₘ₌₁^{M}. Here, the instances may be expressed as a start time (stamp) sₘ, an end time (stamp) eₘ, and an action class cₘ.

The video action localization device may include a feature extractor 100, a memory including a memory update module 200 and a memory queue 300, and a neural network 400.

The feature extractor 100 may include a previously trained video backbone network connected to a linear projection layer. When a segment including L_{S} consecutive video frames is input, the previously trained video backbone network may extract segment features Xₜ from each frame in the segment. Here, Xₜ={xᵢ}_{t-L}_{ₛ}₊₁^{t}∈ [symbol] ^{L}^{ₛ}^{×D} may hold. x may be a frame, i may be an index of a frame in the segment, t may be a timestamp, L_{S} may be a segment length, and D may be a feature vector size of a frame.

The present disclosure may employ a sliding window method of predicting multiple action instances by moving along a temporal axis frame by frame using input segment features. Here, a window size may be equal to a length of an input segment.

The neural network 400 includes a segment encoder 410, an end decoder 420, a start decoder 430, a flag prediction head 440, an end prediction head 450, an action classification head 460, and a start prediction head 470.

Here, the segment encoder 410 and the memory update module 200 may be collectively referred to as a memory-augmented video encoder. The end decoder 420 and the start decoder 430 may be collectively referred to as an instance decoding module.

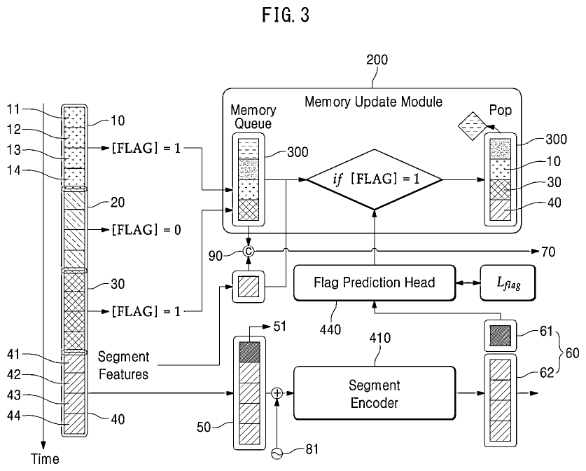

FIG. 3 is a diagram illustrating a segment encoder and a memory queue according to an exemplary embodiment of the present disclosure.

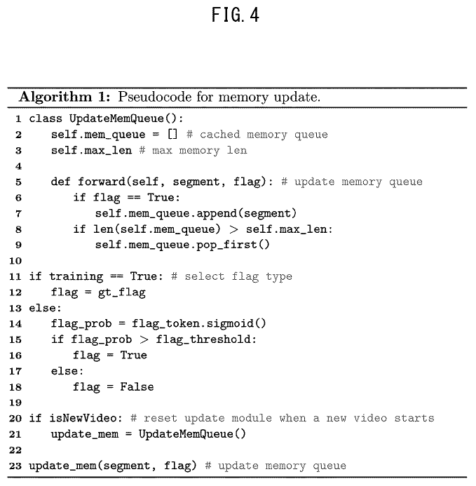

FIG. 4 shows a pseudo code for updating a memory queue according to an exemplary embodiment of the present disclosure.

The following description will refer to FIGS. 2 to 4 together.

According to an exemplary embodiment, each segment may include four frames. For example, segment features 10 may include frame features 11, 12, 13, and 14, and segment features 40 may include frame features 41, 42, 43, and 44. According to another exemplary embodiment, the number of frames included in each segment may vary.

In each time step, input segment features 10, 20, 30, and 40 may be input to the segment encoder 410 and the memory update module 200 which are two modules of the memory-augmented video encoder.

The segment encoder 410 may encode temporal context over segment features, whereas the memory update module 200 may selectively store segment features and update the memory queue 300.

Here, the segment encoder 410 may be a standard transformer encoder including self-attention layers and feed forward networks (FFNs).

To the segment encoder 410, combination data 50 of the segment features 40 and a learnable flag token 51 may be input. In other words, the segment features 40 and the learnable flag token 51 may be concatenated to generate the input data 50. Here, the learnable flag token 51 may have, for example, a default value without any information. An encoded flag token 61 acquired through the segment encoder 410 may have a value for identifying whether the input segment corresponding to the input segment features 40 are related to an action instance. In other words, a flag token may function as a determiner.

Here, the combination data 50 may be converted into queries, keys K, and values V for self-attention. Here, sinusoidal positional encoding Sₚₒₛ 81 may be added to queries and keys of the self-attention layers. Here, Sₚₒₛ∈ [symbol] ^{(L}^{ₛ}^{+1)×D} may hold.

Among output embeddings 60 of the segment encoder 410, the encoded flag token 61 may be input to the memory update module 200. Also, among output embeddings 60 of the segment encoder 410, encoded segment features 62 may be input to the end decoder 420.

In an online environment in which an input for localization is a streaming video, efficiently storing information of past frames and effectively accessing the stored information are very important for detecting an action instance, particularly a long-term action instance of which a temporal range exceeds the size of an input segment. Accordingly, the present disclosure can provide a method of efficiently storing the information of past frames using a memory queue. A memory update method will be described below.

The encoded flag token 61 may be input to the flag prediction head 440.

The flag prediction head 440 may be trained to receive the encoded flag token 61 and predict a flag. Whether to store the input segment features 40 in the memory queue 300 may be determined in accordance with a value predicted by the flag prediction head 440. In other words, only input segment features related to an action instance may be stored in the memory queue 300.

For example, the flag prediction head 440 may be trained to output a value of 1 when frames of an input segment overlap frames of an action instance, and output a value of 0 otherwise.

During training of the neural network 400, a ground-truth flag for an input segment may be provided to the memory update module 200. When the flag has a value of 1 (True), the input segment features 40 may be added to the memory queue 300, and when the flag has a value of 0, the input segment features 40 may be discarded. For convenience of description, FIG. 3 shows that only one frame feature for each of the segment features 10, 30, and 40 is added to the memory queue 300, but actually, features of all frames included in one input segment may be added to the memory queue 300.

During inference of the neural network 400, in the case of sigmoid (ĝ)>θ, an input segment feature may be stored in the memory queue 300. Here, ĝ may be an output logit of the flag prediction head 440, and 0 may be a predefined threshold. In other words, when a predicted flag for an input segment is the threshold or more (i.e., flag_prob>flag_threshold), a flag provided to the memory update module 200 may have a value of 1 (True).

The memory queue 300 may store past input segments on a first-in-first-out (FIFO) basis. A size max_len of the memory queue 300 may be determined in advance, and when the memory queue 300 is full, the oldest segment feature may be deleted.

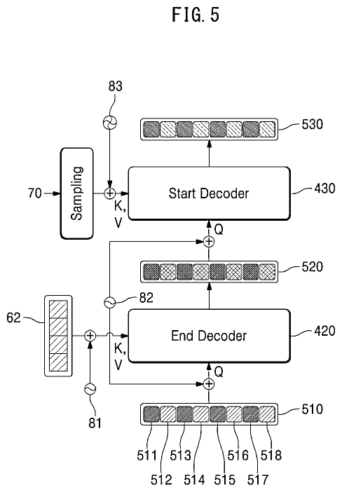

FIG. 5 is a diagram illustrating an instance decoding module according to an exemplary embodiment of the present disclosure.

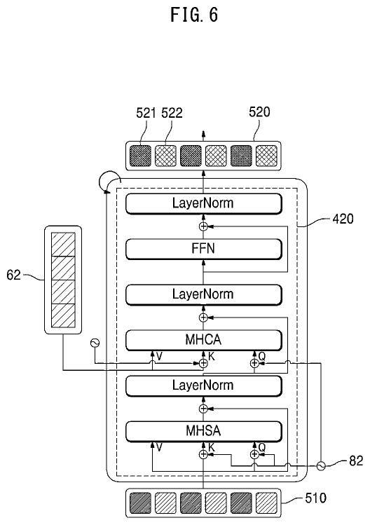

FIG. 6 is a diagram showing an architecture of an end decoder according to an exemplary embodiment of the present disclosure.

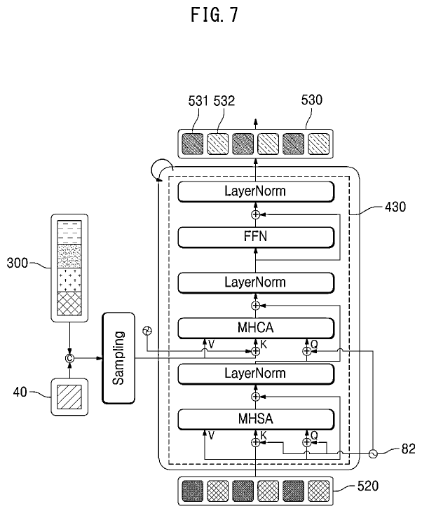

FIG. 7 is a diagram showing an architecture of a start decoder according to an exemplary embodiment of the present disclosure.

The following description will refer to FIGS. 2, 5, 6, and 7 together.

The instance decoding module including the end decoder 420 and the start decoder 430 may localize and classify an action instance using the segment features 62 encoded through an attention mechanism of a transformer and the memory queue 300.

When the encoded segment features 62 with short-term temporal context and the memory queue 300 storing long-term context about latent actions are given, the instance decoding module may be trained to generate action instances for each input segment from a set of 2N instance queries Q. Here, Q={Q_{class}; Q_{bound}}∈ [symbol] ^{2N×D} may hold.

Half of the queries may be related to action class prediction. In other words, half of the queries may be referred to as class queries, and Q_{class}∈ [symbol] ^{N×D} may hold. The other half of the queries may be used for predicting start and end timestamps. The other half of the queries may be referred to as “boundary queries,” and Q_{boundary}∈ [symbol] ^{N×D} may hold.

Pairs of class queries 511, 513, 515, and 517 and boundary queries 512, 514, 516, and 518 for the same instance may share the same positional embedding 82 Eₚₒₛ∈ [symbol] ^{N×D} to accurately identify and distinguish between instances. Here, Q={Q_{class}+Eₚₒₛ; Q_{bound}+Eₚₒₛ} may hold.

For example, instance queries may include four pairs of queries. Here, the same positional embedding 82 may be used for the first pair of queries 511 and 512, the second pair of queries 513 and 514, the third pair of queries 515 and 516, and the fourth pair of queries 517 and 518 to indicate that all the queries are of the same instance. For convenience of description, the positional embedding 82 is shown as a positioning embedding for the four pairs of queries in FIG. 5, but different positional embeddings may be used for the pairs of queries. For example, different positional embeddings may be used for the query 511 and the query 513. When training is performed in this way, it is possible to indicate that a class query (e.g., 511) and a boundary query (e.g., 512) are for different purposes but bound with the same instance.

For example, the same positioning embedding may be used for each pair of instance queries 510 (e.g., the pair of the query 511 and the query 512) input to the end decoder 420 which will be described below, and a corresponding pair of instance queries 520 (e.g., a pair of a query 521 and a query 522) input to the start decoder 430.

As described above, the same positional embedding is used for queries included in one pair, which can improve the predictive performance of the neural network 400.

According to the present disclosure, separate transformer decoders, that is, the end decoder 420 and the start decoder 430, may be used to predict a start offset and an end offset. As shown in FIGS. 6 and 7, the start decoder 430 and the end decoder 420 share the same architecture but may use different information to predict an action start and an action end, respectively.

Specifically, the instance queries (Q) 510, the positional embedding 82 for the instance queries, the encoded segment features 62, and a positional embedding 81 for the encoded segment features 62 may be input to the end decoder 420. The data obtained by adding the positional embedding 81 to the encoded segment features 62 may be used as a key K and a value V for multi-head cross-attention (MHCA) layers of the end decoder 420.

When the encoded segment features 62 and the instance queries 510 are given, the end decoder 420 may be trained to generate an output embedding that is used for detecting a task end around a current timestamp. To this end, the end decoder 420 may include multi-head self-attention (MHSA) layers, the MHCA layers, and an FFN.

The output embeddings 520 of the end decoder 420 may include an end class embedding (e.g., 521) and an end boundary embedding (e.g., 522). The output embeddings 520 may be input to the start decoder 430. An end timestamp and a start timestamp are directly related to each other by inputting the output embeddings 520 to the start decoder 430 such that an action region can be accurately predicted. Among the output embeddings 520, the end class embedding (e.g., 521) may be input to the action classification head 460, and the end boundary embedding (e.g., 522) may be input to the end prediction head 450.

The start decoder 430 may receive the output embeddings 520 of the end decoder 420 and predict an action start corresponding to the output embeddings 520 using the memory queue 300. A process of utilizing the memory queue 300 is as follows.

Referring to FIGS. 3 and 7, segment features stored in the memory queue 300 may be concatenated with segment features 40 input at the current timestamp. Concatenated memory features 70 may be used as long-term context in the start decoder 430. For example, 50% uniform sampling may be performed on the concatenated memory features 70 to acquire uniformly sampled memory features. In other words, since similar information is included in adjacent frames, the memory can be efficiently used via the uniform sampling.

Output embeddings 520 of the end decoder 420, the positional embedding 82 for the output embeddings 520, the uniformly sampled memory features, and two-dimensional (2D) temporal position encoding 83 for the uniformly sampled memory features may be input to the start decoder 430. The data obtained by adding the 2D temporal position encoding 83 to the uniformly sampled memory features may be used as a key K and a value V for MHCA layers of the start decoder 430.

The start decoder 430 may have the same architecture as the end decoder 420. However, as input data, the end decoder 420 receives the encoded segment features 62, whereas the start decoder 430 receives memory features (i.e., uniformly sampled memory features).

The output embeddings 520 of the start decoder 430 may include a start class embedding (e.g., 531) and a start boundary embedding (e.g., 532). Among the output embeddings 530, the start class embedding may be input to the action classification head 460, and the start boundary embedding may be input to the start prediction head 470.

In the present disclosure, to efficiently and effectively utilize the memory queue 300, not only is the foregoing uniform sampling used, but also temporal position encoding may be separated into two parts, a relative segment position and a relative frame position. The scope of position encoding for streaming video of which a duration is unpredictable can be extended via the separation of temporal position encoding. The relative segment position in the memory may be a position of a segment in relation to a current input segment at a segment level. Meanwhile, the relative frame position may be a relative position of a frame in relation to the most recent frame in the same segment.

For example, when the number of frames is 256, 256 indices are required. The indices may represent temporal positions of corresponding frames on a temporal axis. Assuming that 16 frames are included in one segment, there are 16 segments in total. Accordingly, a wider range of positions can be represented using only a total of 36 indices including the 16 segment indices and the 16 indices for frames in a segment.

For example, referring to FIG. 3, the concept of a relative frame position may be applied to the positional encoding 81 which is used as an input of the segment encoder 410. Also, referring to FIGS. 3 and 5 together, the concept of a relative segment position and the concept of a relative frame position may be applied to the 2D temporal position encoding 83.

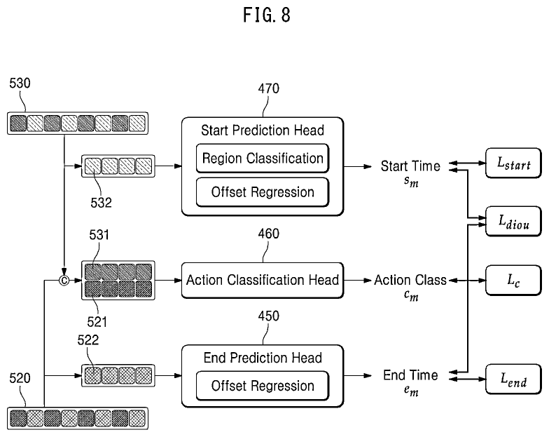

FIG. 8 is a diagram illustrating prediction heads according to an exemplary embodiment of the present disclosure.

To generate N action instances (i.e., {(ŝᵢ, êᵢ, ĉᵢ)}ᵢ₌₁^{N}) from outputs of the end decoder 420 and the start decoder 430, three prediction heads, the end prediction head 450, the action classification head 460, and the start prediction head 470, may be used.

Each of the prediction heads 450, 460, and 470 may be configured as, for example, a 2-layer FFN.

The end prediction head 450 may include an offset regression head. The end prediction head 450 may estimate an end offset between an end timestamp of a target action and a current timestamp. Here, the current timestamp may be a timestamp of a frame that is acquired at the most recent time among frames of input segments. Boundary embeddings (e.g., 522) of the end decoder 420 may be provided to the 2-layer FFN of the end prediction head 450, and the 2-layer FFN may estimate the end offset {ûᵢ}ᵢ₌₁^{N}∈ [symbol] ^{N}.

The start prediction head 470 may estimate an offset between a start timestamp of the target action and the current timestamp.

Unlike the end prediction head 450 that detects the end offset centering on the input segment, the start prediction head 470 may be required to perform offset regression within a relatively wide range. To narrow a range of start offset regression, a time horizon may be divided into Lₘ+2 regions. In other words, the regions may include a previous region in a memory horizon, Lₘ regions covered by the memory, and a region corresponding to the current input segment. In addition, the start prediction head 470 includes a region classification head and an offset regression head, each of which may include a 2-layer FFN.

The start prediction head 470 may receive a boundary embedding (e.g., 532) of the start decoder 430 and predict a start time (timestamp) of the target action.

The region classification head may identify a region to which the start timestamp is assigned, and an output ôᵢ of the region classification head may be represented as {ôᵢ|ôᵢ=argmax(\hat{r}ᵢ)}ᵢ₌₁^{N}∈ [symbol] ^{N}. Here, {\hat{r}ᵢ}ᵢ₌₁^{N}∈ [symbol] ^{N×(L}^{ₘ}⁺²⁾ may be output logits of the region classification head.

The offset regression head may estimate an offset in the regions. An output \hat{v}ᵢ of the offset regression head may be represented as {\hat{v}ᵢ}ᵢ₌₁^{N}∈ [symbol] ^{N×(L}^{ₘ}⁺²⁾. Here, the start offset \hat{v}ᵢ may be calculated for all the Lₘ+2 regions. An offset {\hat{v}ᵢ(ôᵢ)}ᵢ₌₁^{N}∈ [symbol] ^{N} from the identified region may be used for inference.

The start region classification result ôᵢ and the start regression result \hat{v}ᵢ(ôᵢ) may be combined to predict a start timestamp. A final start time offset may be an interval between the start timestamp and the current timestamp which is a timestamp of the last frame of the current segment.

For example, the start region classification result may be output in the form of a probability score. Here, a segment with the largest score may be selected.

In other words, the final start time offset may be a value obtained by adding an offset, which is an offset regression result in the selected segment, to the interval between the current timestamp and the selected segment. More specifically, the final start time offset may be a value obtained by adding an interval between a timestamp of a most recent one of frames in the selected segment and the final start timestamp to an interval between the current timestamp and the timestamp of the most recent frame in the selected segment.

The start prediction head 470 utilizes the region classification head and the offset regression head, whereas the end start prediction head 470 utilizes only the offset regression head and does not utilize a region classification head. The end prediction head 450 may utilize a region classification head, but in this case, frame-specific end classification may be complicated, which may degrade performance. For example, when a region classification head is included in the end prediction head 450, it may be determined first which one of the frames included in the input segment the end timestamp is close to, and then an offset from the determined frame to an actual end timestamp may be predicted. In this case, a difference in time between regional sections is too short, and thus region classification is used as inaccurate information to predict an end timestamp, which may result in an inaccurate prediction. Therefore, the configurations of heads shown in FIG. 8 may be preferable, and stable learning and inference may be possible.

The action classification head 460 may receive an end class embedding (e.g., 521) and a start class embedding (e.g., 531) from the end decoder 420 and the start decoder 430, respectively. Here, to derive a class probability {\hat{p}ᵢ}ᵢ₌₁^{N}∈ [symbol] ^{N×(C+1)}, the class embeddings 521 and 531 may be concatenated and input to the action classification head 460. Here, C may be the number of action classes.

As a result, the neural network 400 may generate N action proposals {(ŝᵢ, êᵢ, ĉᵢ)}ᵢ₌₁^{N} at a time t using Equations 1 to 3 below. Here, the action proposals may be instances predicted by the neural network 400.

$${\hat{s}}_{i} = t - ( {\hat{o}}_{i} + {\hat{v}}_{i} ( {\hat{o}}_{i} ) ) \times {L}_{s} \qquad [ Equation 1 ]$$

$${\hat{e}}_{i} = t + {\hat{μ}}_{i} \times {L}_{s} \qquad [ Equation 2 ]$$

$${\hat{c}}_{i} = arg max ( {\hat{p}}_{i} ) \qquad [ Equation 3 ]$$

Here, L_{S} may be a segment length.

The sliding window method generates N action proposals at each timestamp, and thus postprocessing may be necessary to remove redundant or overlapping action instances and improve performance. Non-maximum suppression (NMS) may be applied to action proposals at each timestamp. Subsequently, proposals significantly overlapping those generated in the past may be removed. To prevent more reliable predictions generated in the future from being removed, instances may also be removed when their predicted end timestamps exceed the current timestamp.

The neural network 400 may be trained to detect action instances of which end times are in a range of [t−T_{d}+1, t+Tₐ] at the timestamp t. Here, T_{d} and Tₐ may represent hyperparameters. Subsequently, a Hungarian algorithm may match ground-truth action instances with the lowest matching cost to action proposals. A matching cost between a ground-truth group i and a proposal σ(i) may be calculated using Equation 4.

$${C}_{i , σ ( i )} = {\hat{p}}_{σ ( i )} ( {y}_{i} ) + IoU ( {b}_{i} , {\hat{b}}_{σ ( i )} ) \qquad [ Equation 4 ]$$

Here, σ may be a permutation of N action proposals, \hat{p}ᵢ may be a class probability of an i^{th} proposal, bᵢ={sᵢ, eᵢ} may be a ground-truth action boundary, and \hat{b}ᵢ={ŝᵢ, êᵢ} may be a predicted action boundary.

In the present disclosure, a focal loss may be used for action classification, a cross-entropy loss may be used for start region classification, and an [symbol] ₁ loss may be used for both start offset regression and end offset regression. An action classification loss L_{class}, a start prediction loss Lₛₜₐᵣₜ, and an end prediction loss L_{end} may be defined as shown in Equations 5, 6, and 7, respectively.

$${L}_{class} = {\sum }_{i = 1}^{N} FL ( {\hat{p}}_{i} , {y}_{i} ) \qquad [ Equation 5 ]$$

$${L}_{start} = {\sum }_{i = 1}^{{N}_{match}} \{ CE ( Softmax ( {\hat{r}}_{i} , {r}_{i} ) + \vert {\hat{v}}_{i} ( {\hat{o}}_{i} ) - {v}_{i} \vert \} \qquad [ Equation 6 ]$$

$${L}_{end} = {\sum }_{i = 1}^{{N}_{match}} \vert {\hat{u}}_{i} - {u}_{i} \vert \qquad [ Equation 7 ]$$

Here, yᵢ, rᵢ, vᵢ, and uᵢ may be a ground-truth action class, a start region, a start offset, and an end offset, respectively.

To provide instance-level supervision and facilitate connection between start and end time prediction, a distance-intersection over union (DIoU) loss L_{diou} may be used. The DIoU loss L_{diou} may be defined as shown in Equation 8.

$${L}_{diou} = {\sum }_{i = 1}^{{N}_{match}} 1 - IoU ( {\hat{b}}_{i} , {b}_{i} ) + \frac{{ρ}^{2} ( {\hat{a}}_{i} , {a}_{i} )}{{d}_{i}^{2}} \qquad [ Equation 8 ]$$

Here, ρ(⋅,⋅) may be a Euclidean distance between two points, âᵢ and aᵢ may be the center of a ground-truth instance, and di may be the length of a box enclosed by the smallest single dimensions.

To train the memory update module 200 in an end-to-end fashion, a flag loss L_{flag} for training the flag prediction head 440 may be used. The flag loss may be calculated as shown in Equation 9.

$${L}_{flag} = BCE ( Sigmoid ( \hat{g} ) , g ) \qquad [ Equation 9 ]$$

Here, ĝ and g may be a logit and a ground-truth flag of a predicted flag token, respectively,

The neural network 400 may be trained in an end-to-end fashion simultaneously using the five losses. An overall loss may be calculated as shown in Equation 10.

$$L = {L}_{class} + {L}_{start} + {L}_{end} + {L}_{diou} + {L}_{flag} \qquad [ Equation 10 ]$$

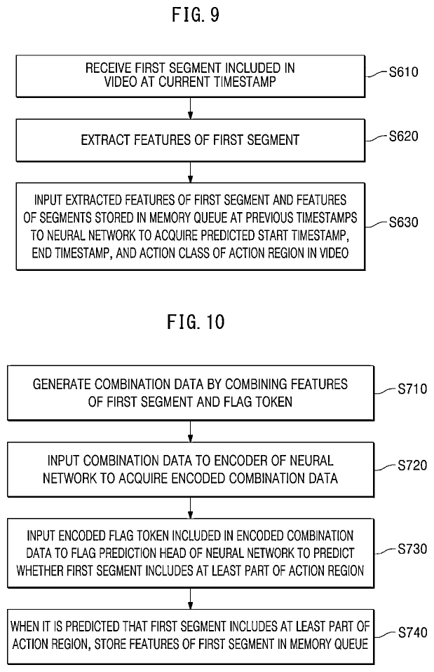

FIG. 9 is a flowchart illustrating a video action localization method according to an exemplary embodiment of the present disclosure.

The video action localization method will be described below with reference to FIGS. 2 to 9 together.

In operation S610, a first segment included in a video may be input to a processor or the feature extractor 100 of the video action localization device at the current time.

In operation S620, the processor or the feature extractor 100 of the video action localization device may extract features 40 of the first segment.

In operation S630, the extracted features 40 of the first segment and features of segments stored in the memory queue 300 at previous timestamps may be input to the neural network 400 of the video action localization device to acquire a predicted start timestamp, end timestamp, and action class of an action region (or action instance) of the video.

Each of the segments stored in the memory queue 300 at the previous timestamps may be a segment satisfying a certain condition. For example, each of the segments stored in the memory queue 300 at the previous timestamps may be a segment predicted to include at least a part of the action region.

The operation S630 may include an operation S631 of generating combination data by combining the features 40 of the first segment and a flag token 51, an operation S632 of acquiring encoded combination data by inputting the combination data to the encoder 410 of the neural network 400, an operation S633 of acquiring an end timestamp of the video action region using the encoded combination data 60, an operation S634 of acquiring a start timestamp of the video action region, and an operation S635 of acquiring an action class of the video action region.

The operation S633 may include an operation of inputting the encoded first segment features 62 included in the encoded combination data 60 and instance queries 510 to the end decoder 420 of the neural network 400 to acquire first output embeddings 520 that are used for detecting whether an action ends in a time period to which the first segment belongs, and an operation of inputting the first output embeddings 520 to the end prediction head 450 of the neural network 400 to predict an end timestamp. Here, the instance queries 510 may include class queries 511, 513, 515, and 517 and boundary queries 512, 514, 516, and 518. An end boundary embedding (e.g., 522) corresponding to the boundary queries among the first output embeddings 520 may be input to the end prediction head 450.

The operation S634 may include an operation of concatenating the extracted features 40 of the first segment and the features of the segments stored in the memory queue 300 at the previous timestamps, an operation of uniformly sampling the concatenated memory features 70, an operation of inputting the sampled memory features and the first output embeddings 520 to the start decoder 430 of the neural network 400 to acquire second output embeddings 530 that are used for predicting the start timestamp of the action region, and an operation of inputting the second output embeddings 530 to the start prediction head 470 to predict the start timestamp. A start boundary embedding (e.g., 532) corresponding to boundary queries among the second output embeddings 530 may be input to the start prediction head 470.

The operation S635 may include an operation of concatenating an end class embedding (e.g., 521) corresponding to the class queries among the first output embeddings 520 and a start class embedding (e.g., 531) corresponding to the class queries among the second output embeddings 530 to generate a concatenated class embedding and an operation of inputting the concatenated class embedding to the action classification head 460 of the neural network 400 to predict an action class of the video.

Among a plurality of pairs of class and boundary queries ({511, 512}, {513, 514}, {515, 516}, and {517, 518}) included in the instance queries 510, the positional embedding 82 may be applied to a first class query (e.g., 511) and a first boundary query (e.g., 512) corresponding to the first class query (e.g., 511).

Here, the same positional embedding 82 may be applied to the instance queries 510 input to the end decoder 420 and the first output embeddings 520 input to the start decoder 430.

FIG. 10 is a flowchart illustrating a process of storing video segments in a memory queue according to an exemplary embodiment of the present disclosure.

The process will be described below with reference to FIGS. 2 to 10 together.

In operation S710, the processor may generate combination data by combining the features 40 of the first segment with the flag token 51.

In operation S720, the combination data may be input to the segment encoder 410 of the neural network 400 to acquire the encoded combination data 60.

In operation S730, the processor may input the encoded flag token 61 included in the encoded combination data 60 to the flag prediction head 440 of the neural network 400 to predict whether the first segment includes at least a part of the action region.

In operation S740, when it is predicted that the first segment includes at least a part of the action region, the features 40 of the first segment may be stored in the memory queue 300.

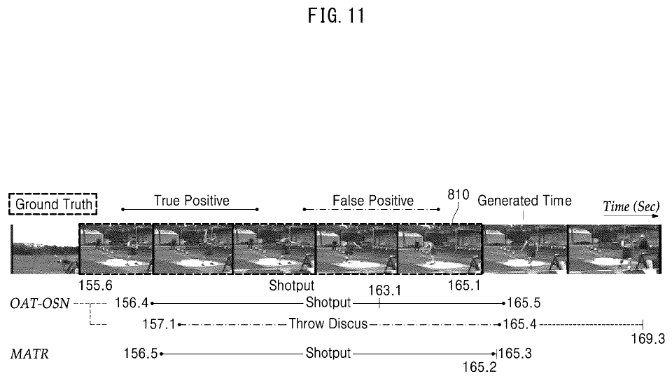

FIG. 11 is a diagram comparatively illustrating results of predicting an action region according to an exemplary embodiment of the present disclosure and the related art.

Comparing an online anchor transformer (OAT)-online suppression network (OSN) model corresponding to instance-level On-TAL according to the related art, the present disclosure MATR, and a ground truth 810, it is seen that the present disclosure predicts closer to the ground truth than the related art (the OAT-OSN model). A timestamp when a predicted instance is generated may be referred to as a “generated time.” According to the present disclosure, there is little difference between a predicted end timestamp and a generated time of an instance.

Specifically, when the predicted action class of the instance is the same as a ground-truth action class and an interval between the predicted start timestamp and end timestamp and an interval between a start timestamp and an end timestamp of a ground truth have an action region intersection over union (IoU) exceeding a threshold, it may be determined that there is a ground-truth label matching the predicted instance. For example, when the predicted instance and the ground truth have the same action class, the IoU may be calculated by taking a union of the predicted instance interval and the ground-truth interval as a denominator and an intersection of the predicted instance interval and the ground-truth interval as a numerator. For example, the threshold may be 0.5.

When there is a ground-truth label matching the predicted instance, this may be referred to as “true positive,” and when there is no ground-truth label matching the predicted instance, this may be referred to as “false positive.”

In FIG. 11, a first prediction of the related art (the OAT-OSN model) and an action class of the present disclosure are shotput which is the same as a ground-truth label, and predicted intervals are similar to the ground-truth label. However, a second prediction of the related art (the OAT-OSN model) shows an action class (throw discus) which is different from the ground-truth label (shotput), and there is a large interval between the generation time and the end time.

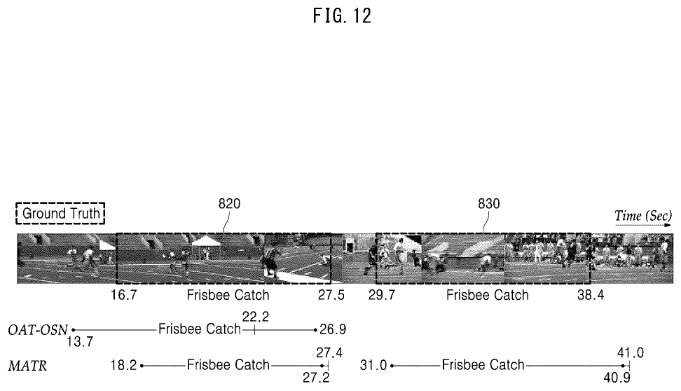

FIG. 12 is a diagram comparatively illustrating results of predicting an action region according to an exemplary embodiment of the present disclosure and the related art.

For a ground-truth label 820, it may be seen that the present disclosure (MATR) has higher accuracy than the related art (the OAT-OSN model). Also, for a ground-truth label 830, a class, a start timestamp, and an end timestamp of a second action are not predicted in the related art (the OAT-OSN model), but are predicted in the present disclosure with similar accuracy to the ground-truth label 820.

As shown in FIG. 12, unlike the related art (the OAT-OSN model), the present disclosure (MATR) can identify a class, a start timestamp, and an end timestamp of an action immediately after the current action ends, and effectively detect an action instance.

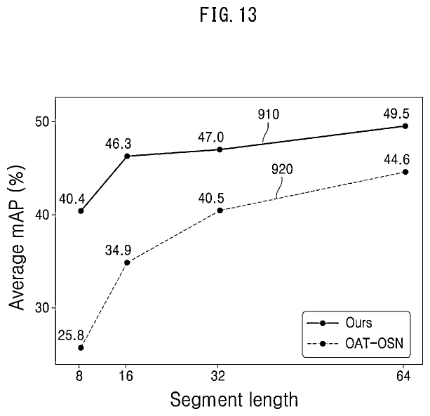

FIG. 13 is a set of graphs of variation in performance versus the length of a segment used for each prediction according to an exemplary embodiment of the present disclosure.

A graph 910 shows the present disclosure, and a graph 920 shows the related art (the OAT-OSN model).

The horizontal axes of the graphs 910 and 920 represent segment length, and the vertical axes represent average mean average precision (mAP) (%).

The OAT-OSN model shows the best performance according to the related art. It may be seen in FIG. 13 that the neural network model of the present disclosure significantly outperforms the OAT-OSN model in terms of overall performance and is more robust to performance variation with segment length.

According to the present disclosure, the elements of the video action localization device may be separated from each other to focus on their own functions, which can improve predictive performance. Specifically, to estimate an action, it is necessary to focus on detecting difference between actions, and to localize an action region, it is necessary to focus on detecting temporal position relationships between frames. To this end, according to the present disclosure, instance queries which are learned for prediction may be classified as prediction queries (class queries) and action localization queries (boundary queries) and learned. In an operation of localizing an action region (boundary prediction), a decoder may be subdivided as an end decoder and a start decoder and used. This is because, to predict an end timestamp of an action region, it is necessary to focus on a point where an action ends, and a large amount of information may actually be unnecessary information (noise). On the other hand, to predict start timestamps of action regions with various lengths, it is necessary to use a memory containing a large amount of information. Therefore, the present disclosure may employ a sequential prediction method of utilizing only currently neighboring frames to predict an end timestamp and additionally utilizing a memory to predict a start timestamp related to the predicted end timestamp.

Although it is shown that four segment features may be stored in the memory queue 300 of the present disclosure, the size of a memory queue may be set differently depending on an embodiment. According to the present disclosure, the size of a memory queue may be selected appropriately for input data.

Although it is shown in the above-described embodiment that a segment length, that is, the number of frames included in a segment, is four, the segment length may be set variously. Even with an increase in the segment length, good predictive performance can be provided.

When queries are separated to predict a start timestamp and an end timestamp as described above in the exemplary embodiment of the present disclosure, it is possible to provide better predictive performance than the related art in which queries are integrated or start and end timestamps are simultaneously predicted.

According to the present disclosure, a real-time video may be received and utilized for, as action localization results, sports highlight generation, closed-circuit television (CCTV) surveillance, criminal activity surveillance and tracking, video summarization, and the like.

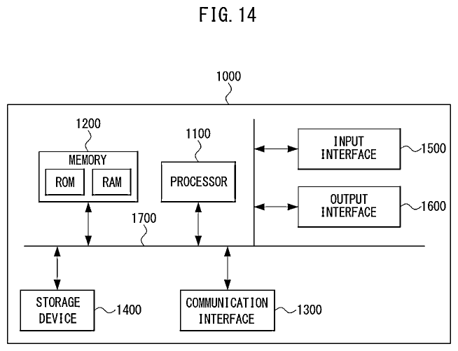

FIG. 14 is a conceptual diagram of an example of a generalized video action localization device or a computing system that may perform at least a part of the process of FIGS. 1 to 13.

At least a partial process of a video action localization method according to an exemplary embodiment of the present disclosure may be performed by a computing system 1000 of FIG. 14.

Referring to FIG. 14, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include at least one processor 1100 and the memory 1200 that stores instructions directing the at least one processor 1100 to perform at least one operation. At least some operations of a method according to an exemplary embodiment of the present disclosure may be performed when the at least one processor 1100 loads instructions from the memory 1200 and executes the instructions.

The processor 1100 may be a central processing unit (CPU), a graphics processing unit (GPU), or a dedicated processor for performing methods according to embodiments of the present disclosure.

Each of the memory 1200 and the storage device 1400 may be at least one of a volatile storage medium and a non-volatile storage medium. For example, the memory 1200 may be at least one of a read-only memory (ROM) and a random access memory (RAM).

The computing system 1000 may include the communication interface 1300 for communicating via a wireless network.

The computing system 1000 may further include the storage device 1400, the input interface 1500, the output interface 1600, and the like.

The components included in the computing system 1000 may be connected via the bus 1700 and communicate with each other.

Examples of the computing system 1000 of the present disclosure may be a desktop computer, a laptop computer, a notebook, a smartphone, a tablet personal computer (PC), a mobile phone, a smart watch, smart glasses, an e-book reader, a portable multimedia player (PMP), a portable game machine, a navigation device, a digital camera, a digital multimedia broadcasting (DMB) player, a digital audio recorder, a digital audio player, a digital video recorder, a digital video player, a personal digital assistant (PDA), and the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A video action localization device comprising:
a memory configured to store at least one instruction;
a processor configured to execute the at least one instruction; and
a neural network,
wherein the processor receives a first segment included in a video at a current timestamp, extracts features of the first segment, and inputs the extracted features of the first segment and features of segments stored in a memory queue of the memory at previous timestamps to the neural network to acquire a predicted start timestamp, end timestamp, and action class of an action region in the video, and
each of the segments stored in the memory queue at the previous timestamps satisfies a certain condition.

2. The video action localization device of claim 1, wherein each of the segments stored in the memory queue at the previous timestamps is predicted to include at least a part of the action region.

3. The video action localization device of claim 1, wherein the neural network includes an encoder and a flag prediction head, and
the processor generates combination data by combining the features of the first segment and a flag token, acquires encoded combination data by inputting the combination data to the encoder, predicts whether the first segment includes at least a part of the action region by inputting an encoded flag token included in the encoded combination data to the flag prediction head, and stores the features of the first segment in the memory queue when it is predicted that the first segment includes at least a part of the action region.

4. The video action localization device of claim 3, wherein the neural network further includes an end decoder and an end prediction head, and
the processor acquires first output embeddings that are used for detecting whether an action ends in a time period to which the first segment belongs by inputting the features of an encoded first segment included in the encoded combination data and instance queries to the end decoder, and predicts the end timestamp by inputting the first output embeddings to the end prediction head.

5. The video action localization device of claim 4, wherein the neural network further includes a start decoder and a start prediction head, and
the processor concatenates the extracted features of the first segment and the features of the segments stored in the memory queue at the previous timestamps, acquires second output embeddings that are used for predicting the start timestamp of the action region by inputting the concatenated memory features and the first output embeddings to the start decoder, and predicts the start timestamp by inputting the second output embeddings to the start prediction head.

6. The video action localization device of claim 5, wherein the instance queries include class queries and boundary queries,
an end boundary embedding corresponding to the boundary queries among the first output embeddings is input to the end prediction head, and
a start boundary embedding corresponding to the boundary queries among the second output embeddings is input to the start prediction head.

7. The video action localization device of claim 6, wherein the neural network further includes an action classification head, and
the processor generates a concatenated class embedding by concatenating an end class embedding corresponding to the class queries among the first output embeddings and a start class embedding corresponding to the class queries among the second output embeddings and predicts the action class of the video by inputting the concatenated class embedding to the action classification head.

8. The video action localization device of claim 5, wherein the processor uniformly samples the concatenated memory features and inputs the sampled memory features and the first output embeddings to the start decoder.

9. The video action localization device of claim 6, wherein the same positional embedding is applied to a first class query and a first boundary query corresponding to the first class query among a plurality of pairs of class and boundary queries included in the instance queries.

10. The video action localization device of claim 6, wherein the same positional embedding is applied to the instance queries input to the end decoder and the first output embeddings input to the start decoder.

11. A video action localization method comprising:
receiving a first segment included in a video at a current timestamp;
extracting features of the first segment; and
acquiring a predicted start timestamp, end timestamp, and action class of an action region in the video by inputting the extracted features of the first segment and features of segments stored in a memory queue at previous timestamps to a neural network,
wherein each of the segments stored in the memory queue at the previous timestamps satisfies a certain condition.

12. The video action localization method of claim 11, wherein each of the segments stored in the memory queue at the previous timestamps is predicted to include at least a part of the action region.

13. The video action localization method of claim 11, further comprising:
generating combination data by combining the features of the first segment and a flag token;
acquiring encoded combination data by inputting the combination data to an encoder of the neural network;
predicting whether the first segment includes at least a part of the action region by inputting an encoded flag token included in the encoded combination data to a flag prediction head of the neural network; and
storing the features of the first segment in the memory queue when it is predicted that the first segment includes at least a part of the action region.

14. The video action localization method of claim 13, wherein the acquiring of the predicted start timestamp, end timestamp, and action class comprises:
acquiring first output embeddings that are used for detecting whether an action ends in a time period to which the first segment belongs by inputting the features of an encoded first segment included in the encoded combination data and instance queries to an end decoder; and
predicting the end timestamp by inputting the first output embeddings to an end prediction head.

15. The video action localization method of claim 14, wherein the acquiring of the predicted start timestamp, end timestamp, and action class further comprises:
concatenating the extracted features of the first segment and the features of the segments stored in the memory queue at the previous timestamps;
acquiring second output embeddings that are used for predicting the start timestamp of the action region by inputting the concatenated memory features and the first output embeddings to a start decoder of the neural network; and
predicting the start timestamp by inputting the second output embeddings to a start prediction head of the neural network.

16. The video action localization method of claim 15, wherein the instance queries include class queries and boundary queries,
an end boundary embedding corresponding to the boundary queries among the first output embeddings is input to the end prediction head, and
a start boundary embedding corresponding to the boundary queries among the second output embeddings is input to the start prediction head.

17. The video action localization method of claim 16, wherein the acquiring of the predicted start timestamp, end timestamp, and action class further comprises:
generating a concatenated class embedding by concatenating an end class embedding corresponding to the class queries among the first output embeddings and a start class embedding corresponding to the class queries among the second output embeddings; and
predicting the action class of the video by inputting the concatenated class embedding to an action classification head of the neural network.

18. The video action localization method of claim 15, wherein the acquiring of the predicted start timestamp, end timestamp, and action class further comprises:
after the concatenating of the extracted features of the first segment and the features of the segments stored in the memory queue at the previous timestamps, uniformly sampling the concatenated memory features; and
inputting the sampled memory features and the first output embeddings to the start decoder.

19. The video action localization method of claim 16, wherein the same positional embedding is applied to a first class query and a first boundary query corresponding to the first class query among a plurality of pairs of class and boundary queries included in the instance queries.

20. The video action localization method of claim 16, wherein the same positional embedding is applied to the instance queries input to the end decoder and the first output embeddings input to the start decoder.
